(19) United States
(12) Patent Application Publication
(10) Pub. No.: US 2011/0037566 A1
(43) Pub. Date: Feb. 17, 2011

(54) Lighting Control System and Method for Operating a Lighting Control System

(76) Inventor: Gotthard Schleicher, Wonneberg (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/989,534

(22) PCT Filed: Apr. 23, 2008
(86) PCT No.: PCT/EP08/54891

§ 371 Date: Oct. 25, 2010

(51) Int. Cl. H04Q 1/00

(52) U.S. Cl. 340/9.1

(57) ABSTRACT

A lighting control system comprising: at least two luminaires (12), a control unit (14) coupled to the at least two luminaires (12) by a communication link (16), by which control unit a respective illuminance of the at least two luminaires (12) can be varied, and comprising at least two sensors (18). Each of the at least two luminaires (12) is assigned at least one sensor (18). The at least two sensors (18) have a first sensitivity at which a first signal can be generated as a result of the sensor (18) being acted upon by a first parameter detectable by the sensor (18), and the respective illuminance can be set in a manner dependent on said first signal. Each of the at least two sensors (18) is adapted to generate an address, wherein the generated address of the respectively addressed sensor can be determined by the control unit (14). The at least two sensors (18) are adapted to have a second sensitivity, wherein the respectively addressed sensor (18) is designed to generate a second signal, which is detectable by the control unit (14), when the sensor (18) having said second sensitivity is acted upon by a second parameter detectable by the sensor (18).

### TECHNICAL FIELD

The invention relates to a lighting control system comprising at least two luminaires, a control unit coupled to the at least two luminaires by means of a communication link, by means of which control unit a respective illuminance of the at least two luminaires can be varied, and comprising at least two sensors, wherein each of the at least two luminaires is assigned at least one sensor. In this case, the at least two sensors have a first sensitivity at which a first signal can be generated as a result of the sensor being acted upon by a first parameter detectable by the sensor, and the respective illuminance can be set in a manner dependent on said first signal. The at least two sensors are designed in each case to generate an address, wherein the generated address of the respectively addressed sensor can be determined by the control unit.

### PRIOR ART

A lighting control system of the generic type is known. In this case, the control unit, by means of a broadcast command (broadcast method), can request the at least two sensors to generate an address. The control unit can use a search algorithm to find the generated addresses of the addressed sensors that are present in the lighting control system. In order to localize the addressed sensors, the control unit causes said sensors to make themselves noticeable. For this purpose, the respective sensor has a flashing luminaire. The flashing sensor is then sought by an operator in order to localize it and to record the installation location of the sensor in the control unit.

What should be regarded as disadvantageous in the case of a lighting control system of this type is the fact that the process of searching for the sensors that make themselves noticeable and thus the process of localizing the sensor can be very lengthy in the case of lighting control systems having large dimensions. Moreover, a signaling device, for instance the flashing luminaire, has to be provided on the sensor.

In accordance with one alternative method known from the prior art, it is possible, for the purpose of generating the address of the sensor, for each sensor to be assigned a specific resistance element, wherein, as a result of the actuation of a switch, the resistance value of the resistance element is interpreted as an address by a computing unit of the sensor. The respective address of the sensors can therefore be generated by the switch being actuated at the respective sensor. The generated address can be communicated by the sensor to the control unit. The process of searching for the sensor generating the respective address is obviated for the operator, but the actuation of the switch on the installed sensor is laborious for the operator, particularly in the case of poorly accessible installation locations.

In accordance with one alternative method known from the prior art, for the purpose of distinguishing sensors, in a lighting control system provision may be made for each of the at least two sensors to be connected to the control unit by means of a specific connecting line. In this way, each of the at least two sensors is distinguishable via the connecting line or selectable by means of the control unit. However, the provision of sensor-specific connecting lines entails a comparatively high outlay when installing the sensors.

### SUMMARY OF THE INVENTION

The object of the present invention is to provide a lighting control system of the type mentioned in the introduction which enables the at least two sensors to be localized in a simplified manner.

This object is achieved by means of a lighting control system comprising the features of patent claim 1 and by means of a method for operating a lighting control system comprising the features of patent claim 16.

Advantageous configurations with expedient developments of the invention are specified in the respective dependent patent claims.

In the case of the lighting control system of the generic type, provision is made for the at least two sensors to be designed to have a second sensitivity, the respectively addressed sensor being designed to generate a second signal, which is detectable by the control unit, when the sensor having said second sensitivity is acted upon by a second parameter detectable by the sensor.

By setting the second sensitivity of the sensor, it is therefore possible to put the latter into a state in which it can make itself noticeable with respect to the control unit on account of the state of being acted upon by the second parameter detectable by the sensor. The provision of a signaling device on the sensor can be dispensed with, as a result of which the sensor can be embodied in a manner constructed more simply. The operator does not have to search for the sensor that makes itself noticeable, as a result of which the process of localizing the at least two sensors can be carried out in a simplified manner and particularly rapidly and efficiently.

Furthermore, a sensor-specific addressing device in the form of the switchable resistance element known from the prior art or in the form of the sensor-specific connecting line can be dispensed with. This reduces outlay in the context of actuating the switch or in the context of installing the lighting control system.

If the sensor having a second sensitivity is embodied as an optical sensor, then the respective sensitivity can advantageously be set in a manner dependent on a respective incidence of daylight into a space illuminated by the luminaire. In the case of comparatively high incidence of daylight, the optical sensor can thus have a comparatively low sensitivity and nevertheless generate the first signal sufficiently distinctly, in a manner dependent on which first signal the respective illuminance of the luminaire assigned to the sensor can be set. Conversely, with comparatively low incidence of daylight, the optical sensor can have a comparatively high sensitivity and thus generate the first signal sufficiently distinctly.

If the second sensitivity of the sensor is greater than the first sensitivity of the sensor, then, after the increased sensitivity of the sensor has been set, by way of example, the surroundings of the optical sensor can be darkened. In this state of the optical sensor, a particularly weak light stimulus is sufficient for generating the second signal of the sensor.

In one advantageous configuration of the invention, the second sensitivity of the sensor is lower than the first sensitivity of the sensor. In this case, the second sensitivity of the optical sensor, for instance, can be reduced relative to the first sensitivity such that the sensor generates no signal, or only a very weak signal, even under comparatively bright ambient conditions. In this state of reduced sensitivity, generation of a signal of the sensor is then made possible by a light stimulus that is particularly intense relative to the ambient brightness. Possibly complex darkening of the surroundings of the optical sensor can be dispensed with.

In an advantageous manner, the second sensitivity of the sensor can be set by means of the control unit. The setting of the sensitivity, which can be effected in a light-based manner, and/or wirelessly, is thereby facilitated for instance relative to manual setting. It is likewise conceivable for the sensor embodied as optical sensor to set the respective sensitivity automatically in a manner dependent on the undershooting or overshooting of a predeterminable value of the brightness of the incident daylight.

It has been found to be furthermore advantageous if the lighting control system comprises an initialization means, wherein the respectively addressed sensor is designed to interact with the initialization means in such a way that the sensor having the second sensitivity generates the second signal detectable by the control unit if the respectively addressed sensor is acted upon by the second parameter detectable by the sensor by means of the initialization means. If, as in the case of optical sensors, the parameter detectable by the sensor is light, then the initialization means used can be an intense light source, for example a flashlamp, a laser pointer or the like for acting upon the sensor with light. Only the sensor acted upon by means of the initialization means thus generates the second signal, which is communicated to the control unit.

The process of acting upon the sensor with the parameter detectable by the sensor can thereby be effected particularly flexibly, over a distance corresponding to a range of the initialization means, and in accordance with the logistics desired by the operator. In this case, the sensors acted upon by the second parameter detectable by the sensor can be selected particularly simply by the operator handling the initialization means.

In an advantageous manner, the control unit is designed to allocate an operating address to that one of the at least two sensors which generates the second signal resulting from being acted upon by means of the initialization means. As operaₜing addresses, it is possible, particularly if the lighting control system operates according to the so-called DALI standard (Digital Addressable Lighting Interface) to allocate short addresses which enable a particularly rapid response of the sensors. According to the DALI standard, the short addresses have a length of 6 bits. Furthermore, a sensor can be combined with one or more luminaires assigned to said sensor with use of operating addresses to form a group.

Furthermore, it has proved to be advantageous if the initialization means is designed to allocate an operating address to that one of the at least two sensors which is acted upon by the second parameter detectable by the sensor by means of the initialization means. As a result, the allocation of the operating address when the sensor is acted upon by the parameter detectable by the sensor can be effected particularly flexibly over the distance corresponding to the range of the initialization means, and in accordance with the logistics desired by the operator.

In a further advantageous configuration of the invention, the at least two sensors are designed to generate the in each case one address, which can be determined by the control unit, as a random address. When generating random addresses, in particular in the case of random addresses which have a length of 24 bits according to the DALI standard, it is particularly certainly ensured that each sensor generates a unique address.

Furthermore, it has been found to be advantageous if at least two sensors are designed to communicate an addressed state. By way of example, the sensor can communicate that an address has already been allocated to it and renewed addressing is not possible in the context of a current start-up of the lighting control system. Alternatively, by means of the sensor it is possible to communicate a question as to whether a renewed addressing of the sensor with a new address is desired. The lighting control system is thereby particularly flexible since a further sensor can also subsequently be integrated into the lighting control system in a simple manner.

In one advantageous configuration of the invention, the control unit is designed to store spatial information which can be assigned to the sensor, in particular graphical and/or textual spatial information. After the localization of the sensor by the operator, the operator can therefore input the spatial information, providing information about the installation location of the sensor, into the control unit. In this case, the graphical spatial information can comprise a layout plan, and the textual spatial information can comprise a textual description of the installation location of the sensor. This enables the control unit to assign the installation location of the sensor, therefore the location of signal generation, to the address of the sensor, in particular to its operating address.

In a further advantageous manner, the lighting control system has a, in particular graphical, user interface, which is designed to communicate information which can be assigned to the sensor and/or to the luminaire. As a result, a functionality of the lighting control system can be illustrated, in particular visualized, in a simple manner. By way of example, it is possible to communicate which sensors are currently generating a signal and/or how intense a signal is being generated by the sensor. A currently present illuminance of the luminaire can likewise be communicated.

It is furthermore advantageous if the information which can be assigned to the sensor and/or to the luminaire comprises spatial information, in particular graphical and/or textual spatial information. The installation location of the sensor and/or of the luminaire can thereby be communicated to a user of the lighting control system, for instance the operator.

In an advantageous manner, the at least two sensors are connected in parallel. As a result, an installation outlay for installing the sensors is particularly low and diverse topologies are made possible for fitting the sensors. Furthermore, further sensors can thus be subsequently added to the lighting control system in a particularly simple manner. In addition, a control unit which has only one input for connecting sensors can be used for the lighting control system, selection of the individually addressed sensor nevertheless being made possible.

In a further advantageous configuration of the invention, the at least two sensors comprise an optical sensor and/or a presence sensor. The presence sensor can be embodied as a passive sensor which, for instance, detects infrared radiation from the surroundings, and/or as an active sensor which can emit and receive ultrasound and/or electromagnetic waves. The presence sensor can likewise have an optical sensor which can be acted upon by light for example for the initialization of the sensor by means of the initialization means.

This makes it possible to set constant light values in a space illuminated by the luminaire in a manner dependent, for instance, on the incidence of daylight into the space. Furthermore, particularly economical operation of the lighting control system is made possible if the luminaire is operated only when the presence sensor detects the presence of a person in the space.

Furthermore, it has been found to be advantageous if the sensor assigned to a luminaire is embodied such that it is integrated into the luminaire. As a result, during the cabling of the luminaire, the sensor can be concomitantly cabled in a particularly simple manner.

If the lighting control system that enables individual driving of operating units of the luminaires, for example electronic ballasts, by means of the control unit operates according to the DALI standard, a five-core cable instead of a conventional three-core cable can be used for the cabling of the luminaires. In this case, it is recommended to use the two free cores for DALI and to connect the sensors like the operating units of the luminaires to the DALI line.

Finally, the lighting control system can be integrated into a building management system in which the at least two sensors comprise a temperature sensor and/or an air humidity sensor and/or an air quality sensor. When the lighting control system is integrated into the building management system, temperature sensors, air humidity sensors and/or air quality sensors concomitantly cabled with the optical sensors and/or presence sensors can be used for economical and efficient operation of the building management system. In this case, by way of example, information supplied by the temperature sensors, air humidity sensors and/or air quality sensors is utilized for operating air-conditioning apparatuses, for instance. In this case, the generation of the addresses of the temperature sensors, air humidity sensors and/or air quality sensors and the allocation of operating addresses are effected analogously to the method described for the optical sensors and/or presence sensors.

The preferred embodiments and advantages described for the lighting control system according to the invention are also applicable to the method according to the invention for operating a lighting control system.

### BRIEF DESCRIPTION OF THE DRAWING

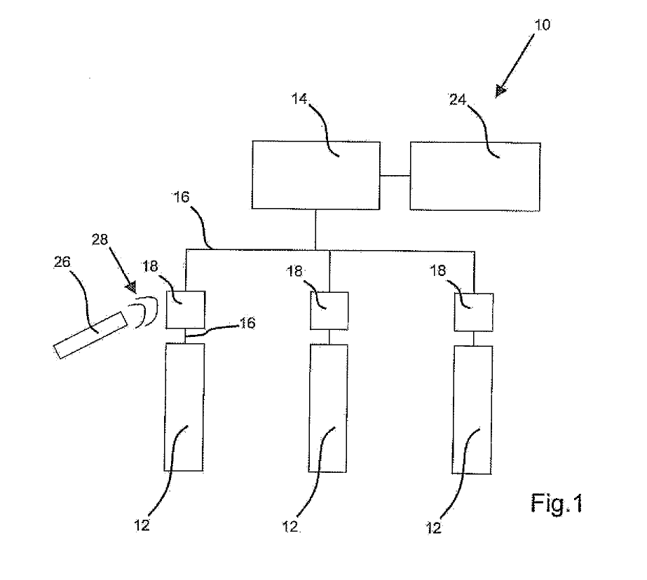

The invention is explained in greater detail below on the basis of exemplary embodiments. FIG. 1 shows a schematically depicted construction of a lighting control system comprising luminaires and sensors.

### PREFERRED EMBODIMENT OF THE INVENTION

FIG. 1 schematically shows a lighting control system 10, in which two luminaires 12 are connected to a control unit 14. A respective illuminance of each individual one of the three luminaires 12 can be varied separately by means of the control unit 14. The luminaires 12 are coupled to the control unit 14 by means of a communication link, which is embodied as a control line 16 in the present case. In an alternative embodiment of the lighting control system 10, the communication link can enable a response of the luminaires 12 in a manner without the use of cables, that is to say wirelessly.

The communication of control commands of the control unit 14 to the individual luminaires 12 is preferably effected in accordance with the so-called DALI standard (Digital Addressable Lighting Interface), which enables the luminaires 12 to be switched on and off and also to be dimmed.

The lighting control system 10 furthermore comprises three sensors 18, each luminaire 12 being assigned a sensor 18. In the present case, each of the three sensors 18 is connected in series with the respective luminaire 12 and coupled to the control unit 14 by means of the communication link 16. In alternative embodiments, sensors 18 and luminaires 12 can also be connected in parallel.

In the present case, the sensors 18 are embodied as optical sensors, a detection region of the sensor 18 not being influenced directly by the light from the luminaire 12. The sensor 18 therefore registers a sum of reflected daylight and light generated by the luminaire 12. The illuminance of the luminaire 12 can thus be reduced depending on the incident daylight.

The control unit 14 requests the sensors 18, by means of a broadcast command, therefore in a broadcast method, in accordance with the DALI standard, in each case to generate a random address having a length of twenty-four bits. The control unit 14, by means of a search algorithm, subsequently determines the random addresses, of the sensors 18, present in the lighting control system.

In order to localize the sensors 18, a sensitivity of the sensors 18 having the random address is reduced by means of the control unit 14. The optical sensors 18 are therefore set to be sufficiently insensitive that sensors 18 generate no signal even in the case of comparatively high illuminance of the luminaires 12 and upon incidence of daylight.

An operator can thereupon act upon the optical sensor 18 with intense light in a targeted manner by means of an initialization means 26, which is embodied for example as an intensely focused flashlamp, laser pointer or the like. The process of acting upon the sensors 18 with light as a parameter detectable by the sensor 18 is illustrated by symbols 28 in FIG. 1.

It goes without saying that the sensors 18 can supplementarily or alternatively be embodied as presence sensors. If the sensors 18 are alternatively embodied as presence sensors that detect infrared radiation, then the sensors 18 can be acted upon in a targeted manner by an intense infrared radiation that can be provided by the initialization means 26.

As a result of the fact that the optical sensor 18 which has the random address and whose sensitivity was reduced is acted upon by the intense light of the initialization means 26, the sensor 18 generates a signal, which is detected by the control unit 14.

Consequently, sensor 18 is localized by the operator as a result of being acted upon by light of the initialization means 26. The optical sensors 18 can, in turn, be acted upon by the intense light by means of the initialization means 26, and thereby be selected. By means of the initialization means 26, therefore, it is possible for the operator to localize each of the sensors 18 in a targeted manner and in accordance with logistics chosen by the operator during the initialization of the sensors 18.

Spatial information identifying the localized sensor 18, for instance the installation location of the sensor 18, is thereupon stored in the control unit 14 by the operator. The localized sensor 18 is additionally allocated an operating address, which in the present case is embodied as a short address having a length of six bits according to the DALI standard. The allocation of the operating address to the sensor 18 can be effected by the control unit 14 or be performed by the operator.

In the present case, the control unit 14 has a graphical user interface 24 by means of which information concerning the sensor 18 and the luminaire 12 can be displayed to the operator.

If one of the sensors 18 has already been addressed and if, with reduced sensitivity, it is acted upon by the parameter detectable by the sensor 18 by means of the initialization means 26, then the fact that the sensor 18 has already been addressed can be displayed by means of the graphical user interface 24.

The sensor 18 can be designed such that renewed addressing is made possible or that the sensor 18 merely communicates, preferably via the graphical user interface 24, that the sensor 18 has already been addressed.

Furthermore, the graphical user interface 24 can be embodied such that it is integrated into the control unit 14. By means of the graphical user interface 24, functionalities of the luminaires 12 and of the sensors 18 can be communicated particularly clearly by display to the operator and/or to a further user of the lighting control system 10.

1. A lighting control system comprising:
at least two luminaires;
a control unit coupled to the at least two luminaires by a communication link, by which control unit a respective illuminance of the at least two luminaires can be varied, and comprising at least two sensors, wherein each of the at least two luminaires is assigned at least one sensor,
wherein the at least two sensors have a first sensitivity at which a first signal can be generated as a result of the sensor being acted upon by a first parameter detectable by the sensor, and the respective illuminance can be set in a manner dependent on said first signal,
wherein each of the at least two sensors is adapted to generate an address, wherein the generated address of the respectively addressed sensor can be determined by the control unit, and wherein the at least two sensors are adapted to have a second sensitivity, wherein the respectively addressed sensor is designed to generate a second signal, which is detectable by the control unit, when the sensor having said second sensitivity is acted upon by a second parameter detectable by the sensor.

2. The lighting control system as claimed in claim 1, wherein the second sensitivity of the sensor is lower than the first sensitivity of the sensor.

3. The lighting control system as claimed in claim 1, wherein the second sensitivity of the sensor can be set by means of the control unit.

4. The lighting control system as claimed in claim 1, wherein the lighting control system comprises an initialization means, wherein the respectively addressed sensor is adapted to interact with the initialization means in such a way that the sensor having the second sensitivity generates the second signal detectable by the control unit if the respectively addressed sensor is acted upon by the second parameter detectable by the sensor by means of the initialization means.

5. The lighting control system as claimed in claim 4, wherein the control unit is adapted to allocate an operating address to that one of the at least two sensors which generates the second signal resulting from being acted upon by means of the initialization means.

6. The lighting control system as claimed in claim 4, wherein the initialization means is adapted to allocate an operating address to that one of the at least two sensors which is acted upon by the second parameter detectable by the sensor by means of the initialization means.

7. The lighting control system as claimed in claim 1, wherein the at least two sensors are adapted to generate the in each case one address, which can be determined by the control unit, as a random address.

8. The lighting control system as claimed in claim 1, wherein the at least two sensors are adapted to communicate an addressed state.

9. The lighting control system as claimed in claim 1, wherein the control unit is adapted to store spatial information which can be assigned to the sensor, in particular graphical and/or textual spatial information.

10. The lighting control system as claimed in claim 1, wherein the lighting control system has a user interface, which is adapted to communicate information which can be assigned to the sensor and/or to the luminaire.

11. The lighting control system as claimed in claim 10, wherein the information which can be assigned to the sensor and/or to the luminaire comprises spatial information, in particular graphical and/or textual spatial information.

12. The lighting control system as claimed in claim 1, wherein the at least two sensors are connected in parallel.

13. The lighting control system as claimed in claim 1, wherein the at least two sensors comprise an optical sensor and/or a presence sensor.

14. The lighting control system as claimed in claim 1, wherein the sensor assigned to a luminaire is integrated into the luminaire.

15. The lighting control system as claimed in claim 1, wherein the lighting control system is integrated into a building management system in which the at least two sensors comprise a temperature sensor and/or an air humidity sensor and/or an air quality sensor.

16. A method for operating a lighting control system comprising:
at least two luminaires,
a control unit coupled to the at least two luminaires by means of a communication link, by means of which control unit a respective illuminance of the at least two luminaires can be varied, and comprising
at least two sensors, wherein each of the at least two luminaires is assigned at least one sensor,
wherein the at least two sensors have a first sensitivity at which a first signal can be generated as a result of the sensor being acted upon by a first parameter detectable by the sensor, and the respective illuminance can be set in a manner dependent on said first signal,
wherein the at least two sensors in each case generate an address, and wherein the generated address of the respectively addressed sensor is determined by the control unit,
wherein a second sensitivity of the at least two sensors is set, wherein the respectively addressed sensor generates a second signal, which is detectable by the control unit, when the sensor having said second sensitivity is acted upon by a second parameter detectable by the sensor.

17. The lighting control system as claimed in claim 10, wherein the user interface is a graphical user interface.
